(19) United States
(12) Patent Application Publication
(10) Pub. No.: US 2010/0211195 A1
(43) Pub. Date: Aug. 19, 2010

(54) Method for Logical Connection of Safety Circuits in an Industrial Automation Arrangement, and Configuration Device for Carrying Out the Method

(75) Inventors: Harald Gebuhr, Nurnberg (DE); Michael Schlosser, Schwabach (DE); Sören Zühlsdorf, Nurnberg (DE)

Correspondence Address: COHEN, PONTANI, LIEBERMAN & PAVANE LLP, 551 FIFTH AVENUE, SUITE 1210, NEW YORK, NY, 10176, US

(73) Assignee: Siemens AG, Munchen (DE)

(21) Appl. No.: 12/703,856

(22) Filed: Feb. 11, 2010

(30) Foreign Application Priority Data
Feb. 11, 2009 (EP) 09001919

(51) Int. Cl. G05B 9/02

(52) U.S. Cl. 700/79

(57) ABSTRACT

A method and a programmer for logical connection of a plurality safety circuits in an industrial automation arrangement, wherein a subordinate one of the safety circuits and a super-ordinate one of the safety circuits are each described in a safety matrix. An overall matrix is generated from the safety matrices of the subordinate and super-ordinate safety circuits and the overall matrix indicates the connection of the safety circuits and is automatically converted into a safety-related program.

### BACKGROUND OF THE INVENTION

The invention relates to a method for logical connection of a plurality of safety circuits or safety areas in an industrial automation arrangement, and to a configuration device for an industrial automation arrangement.

A multiplicity of (generally electrical) equipment items, which are controlled by automation components, are normally arranged in industrial automation arrangements. The equipment items and the technical devices operated by them can lead to a multiplicity of hazards. For example, people may be struck and injured by rotating or moving part, electrical voltages can cause electric shocks or pipelines can burst if the pressure is too high. For this reason, it is a normal practice to provide safety measures for all equipment items which could cause a hazard. This generally means that the relevant equipment items are automatically or manually switched off in the event of a hazard. So-called “emergency-stop switches” or emergency-stop buttons are generally used for manual deactivations. By way of example, light barriers or door contacts, or else measurements of analog process variables, are used for switching equipment items off automatically, which ensure that, when someone approaches a moving machine part, the movement is stopped (for example by switching off a motor) or a process is switched to the safe state, such as by opening a safety valve in the event of an overpressure. The combination of a switching-off means, such as an emergency-stop switch or light barrier and the respective equipment item (i.e., a motor or circuit) is in this case referred to as a safety circuit or safety instrumented function (SIF).

Here, safety circuits can also be interlocked with one another, i.e., a super-ordinate safety circuit is super-ordinate to a subordinate safety circuit, such as comprising an emergency-off switch and an equipment item, in which case a multiplicity of subordinate safety circuits are generally subordinate to the super-ordinate safety circuit. For example, a production building may be equipped with a fire alarm system, in which all of the machines and installations, which each have their own safety circuits and which are located in the building, are switched off in the event of a fire. The fire alarm system is therefore a component of a super-ordinate safety circuit, in which case the “fire” status is an initiating condition (“cause”) for the switching-off process, which is passed on as the “effect” to the subordinate safety circuits. As a result, “effect” of the super-ordinate safety circuit acts as the “cause” on the subordinate safety circuits.

When industrial automation arrangements are being configured, the safety circuits of the equipment items are in general configured in parallel for this purpose. Here, the causes and effects of the various safety circuits because of the complexity of many industrial automation arrangements are in this case significantly linked to one another. The configuration of a safety concept for a complex industrial automation arrangement such as this is therefore a complex process overall, in which the frequently required verification of a functioning safety concept can also frequently be represented only with difficulty, because of the lack of clarity.

Because of the large number of equipment items which have to be monitored, one problem that often arises in relatively large safety-related automation projects is that it is no longer possible to clearly and comprehensively represent the relationships. The configuration of the safety concept is therefore made more difficult due to a lack of clarity. Here, the safety circuits are subdivided into small switching-off groups, i.e., “island solutions”, and are configured and accepted (by authorities, the technical licensing authority, or the like) in this way. Consequently, a relatively large conventional safety-related project comprises a large number of small sub-projects which each represent safety circuits and must be connected by manually configured cross-communication.

### SUMMARY OF THE INVENTION

It is therefore an object of the present invention to simplify the configuration of the connection of safety circuits in industrial automation arrangements and, furthermore, to provide a clear representation of the safety circuits in a simple manner.

This and other objects and advantages are achieved in accordance with the invention by a configuration device and by a method for logical connection of at least two safety circuits in an industrial automation arrangement, where a sub-ordinate one of the safety circuits and a super-ordinate one of the safety circuits are each described in a safety matrix. Here, an overall matrix is generated from the safety matrices of the subordinate and of the super-ordinate safety circuits, where the overall matrix indicates the connection of the safety circuits.

The objects of the invention are also achieved by a configuration device for an industrial automation arrangement, in which the configuration device is configured to perform one of the abovementioned methods partially or fully automatically.

The abovementioned method and the abovementioned configuration device mean that, for a given automation arrangement with a given hierarchy of the equipment items, all that is necessary is to configure the safety circuits of the individual equipment items in the form of relatively small safety matrices. Here, the overall matrix can be generated largely automatically by the relationships between the individual safety circuits. Moreover, the overall matrix clearly indicates the safety concept, i.e., the connection of the various safety circuits to one another, and can also be used to make it easier to process the relationships.

The generation of the overall matrix can easily be automated if, in order to generate the overall matrix, the safety matrix of the subordinate safety circuit is inserted together with the logic links contained therein into the safety matrix of the super-ordinate safety circuit. In order to distinguish between subordinate and super-ordinate safety circuits, the safety circuits are advantageously recorded in a project description of the industrial automation arrangement, where the hierarchy of the safety circuits and the hierarchy of the mutually associated safety matrices assigned to the latter are read from a resource hierarchy and/or a group hierarchy in the project description of the industrial automation arrangement. Here, information which is available in any case can easily be reused if a representation of the industrial automation arrangement in the form of a tree structure is used as the project description.

The automatic processing of the individual safety matrices is made easier in that an effect which is linked to an initiating condition (cause) is defined for each of the safety matrices, where the effect of each originally super-ordinate safety matrix in the overall matrix acts as an initiating event on a safety matrix which is subordinate to it. In this case, of course, an effect of a super-ordinate safety matrix can also act as an initiating event on a multiplicity of subordinate safety matrices. Furthermore, additional logic links between originally individual safety matrices which are not the result of a hierarchical relationship within the originally configured industrial automation arrangement can also be inserted in the overall matrix. In addition, automatically produced logic links which represent a result of the hierarchical arrangement of the equipment items can also—generally manually—be removed from the overall matrix to remove undesired relationships.

The overall matrix that is produced can advantageously be used more than once, specifically on the one hand to produce a safety-related program for the industrial automation arrangement, and on the other hand to represent the safety relationships in the industrial automation arrangement. The latter representation can also be used to verify the safety concept for technical acceptance by authorities or the like.

A particularly simple transfer of the information from the configured automation arrangement is made easier by the technical devices, which are used to generate the overall matrix and to further process the overall matrix in the form of a software component of a programmer or a configuration tool for the industrial automation arrangement.

Auxiliary logic that is generated improves the legibility of the overall matrix and can be used for documentation purposes. The required run-time-optimized or memory-optimized code is compiled without the auxiliary logic that is generated. The auxiliary logic that is generated is composed of the columns which, as an “effect”, contain only representatives of hierarchy levels.

Other objects and features of the present invention will become apparent from the following detailed description considered in conjunction with the accompanying drawings. It is to be understood, however, that the drawings are designed solely for purposes of illustration and not as a definition of the limits of the invention. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the method according to the invention will be described in the following text with reference to the drawings. This is intended at the same time to explain a configuration device according to the invention, in which:

FIG. 1 shows a schematic illustration in the form of a tree structure of safety-relevant components of an industrial automation arrangement;

FIG. 2 shows an example of an installation layout for the safety circuits of a part of the industrial automation arrangement of FIG. 1, comprising the following safety circuits:

| | |
|---|---|
| Installation level | (A-E) |
| Emergency-off level | (N-A-E) |
| Protection circuit level | (SK-E) |
| Insertion-point level | (ES-E) |
| Unit level | (AG-E) |
| Actuator level | (AK-E); |

FIG. 3 shows the generation of an overall matrix comprising three individual safety matrices;

FIG. 4 shows the overall matrix that is generated; and

FIG. 5 is a flow chart showing the method in accordance with an embodiment of the invention.

### DETAILED DESCRIPTION OF THE PRESENTLY PREFERRED EMBODIMENTS

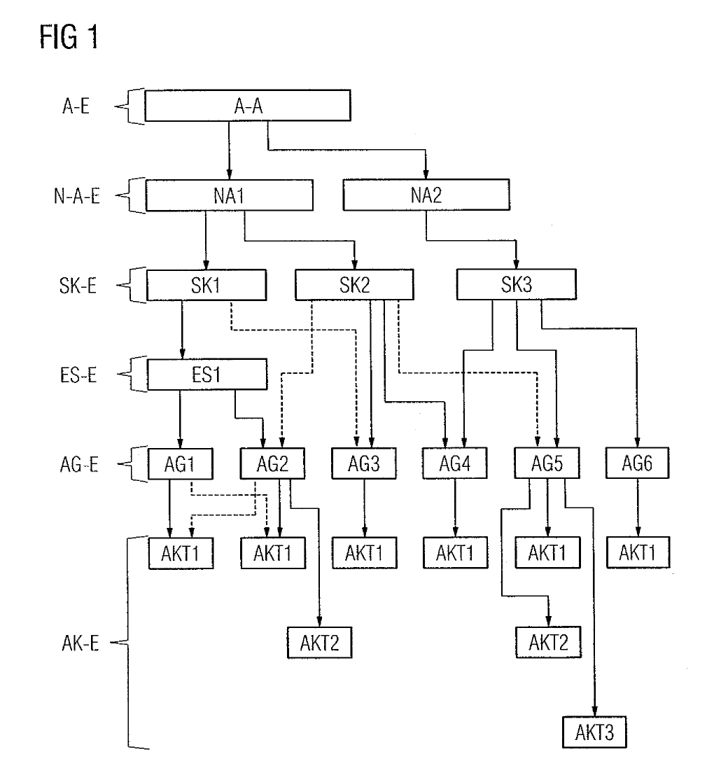

FIG. 1 shows the safety-relevant relationships in an industrial automation arrangement, schematically and in the form of a tree structure. Here, the overall automation arrangement A-A is arranged under the hierarchically uppermost level, i.e., the installation level A-E. The emergency-off circuits NA1, NA2 are arranged in the level below, i.e., the emergency-off level N-A-E. The level N-A-E is super-ordinate to the protection circuit level SK-E, in which the protection circuits SK1, SK2, SK3 are arranged. The level SK-E is super-ordinate to the insertion-point level ES-E with the insertion point ES1. The units AG1, AG6 are arranged as equipment items of the automation arrangement in the next level, i.e., the unit level AG-E. Finally, the actuator level AK-E, in which the actuators AKT1, AKT2, AKT3 are arranged, is shown as the lowermost hierarchy level. The number of hierarchy levels which are passed through in the switching-off chain is independent of the number of hierarchy levels in the installation. If, for example, the insertion point safety circuit is missing in the switching-off chain relating to AG4, then the safety circuit SK2 acts directly.

In the illustrated tree structure, each element in each branch of the tree in each hierarchy level passes on its own “effect” to the respectively subordinate level. Consequently, for example, when the emergency-off circuit NA1 is activated, i.e., when the corresponding emergency-stop button is operated, the protection circuits SK1, SK2 which are subordinate to this are initiated, which in this example means that the appliances, installations and components which belong to the protection circuits SK1, SK2 are switched to a safe operating state, e.g., they are switched off. It can thus be said that the “effect” of the emergency-off level N-A-E as the “cause”, i.e., as the “initiating condition” is passed on to the subordinate hierarchy level. These conditions are represented by arrows in FIG. 1. A cause-and-effect chain such as this is also referred to as “father-and-son relationship” within one branch or arm of the tree structure. These relationships result automatically from the configuration of the automation arrangement. As a result, logical relationships between components of the automation arrangement, which are defined during the configuration of the automation arrangement, can be automatically transferred to relationships in the safety project. This is done by a programmer (“engineering tool”) which operates by suitable configuration software, which is provided with an appropriate plug-in, i.e., an additional software component, having this functionality.

Relationships which extend beyond the “father-and-son relationships” and which cannot be read as such from the configuration of the automation arrangement are represented by dashed arrows in FIG. 1. These relationships are also referred to as “uncle-and-nephew relationships”, and are configured manually. Undesired relationships which have been automatically transferred from the configured automation arrangement to the safety concept can likewise be deleted manually. For the representation shown in FIG. 1, this would mean that corresponding arrows were removed. It is likewise a defined convention that, although a super-ordinate level can switch off, or even should switch off a subordinate level (in the event of a fault), the switch-off of a subordinate level may not, however, conversely lead to the super-ordinate level being switched off automatically, and therefore in doubt to the overall automation arrangement being switched off automatically.

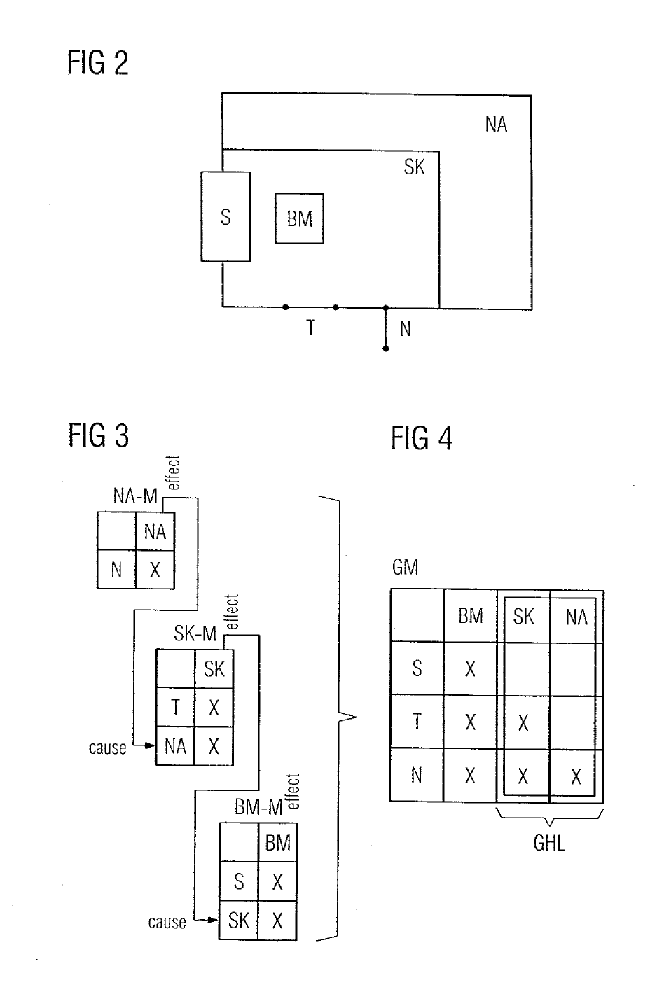

FIG. 2 shows the layout of a simple installation. Here, an equipment item BM, such as a machine tool, is embedded in a protection circuit SK, with a scanner S, such as a “light curtain”, being provided whose initiation means that someone is approaching the machine tool and is in danger, as a result of which the machine must be switched off. A further safety element is a contact on an access door T, in which case opening the door should likewise lead to the equipment item BM being switched off. An emergency-stop button N is also provided, by which the equipment item BM can be switched off manually. Here, the emergency-stop button N is logically associated with the emergency-off circuit NA.

The individual safety matrices which result from the layout shown in FIG. 2 are illustrated in FIG. 3. Here, the safety matrix NA-M (emergency-off circuit) illustrated at the top contains a line with a switch-off condition, with the designation “N” in the first column denoting the emergency-stop button and in which the “X” arranged in the next column indicates that operation of the emergency-stop button N represents a switch-off condition for the safety matrix NA-M. The next safety matrix SK-M represents the protection circuit SK from FIG. 2. Two lines with switch-off conditions can be seen in this matrix, specifically on the one hand the protected door T, whose operation is intended to lead to the elements of the protection circuit SK being switched off and, next, the emergency-off circuit NA, to which the protection circuit SK belongs. The matrix of the equipment item BM is illustrated as the third safety matrix BM-M in which both the scanner S and the protection circuit SK are included as switch-off conditions.

Each hierarchy level or safety matrix can therefore be associated with switch-on and switch-off functions; however, in the illustrated example, only switch-off functions are shown for purposes of clarity. Here, it is an object to associate the “effect” of the super-ordinate hierarchy level or of the super-ordinate safety matrix as the “cause” on the subordinate safety matrix, automatically. This is represented by the arrows in FIG. 3. At the installation level (cf. the level A-E in FIG. 1), one main switch switches the entire installation off. At the emergency-off circuit level, an emergency-off button results in a sub-area being safely switched off (in this case, for example, the installation from FIG. 2). At the protection circuit level, a working area is switched off safely by access doors, safety light barriers or scanners. At the insertion-point level (see the level ES-E in FIG. 1), a plurality of units which are a danger to someone can be switched off safely. At the unit level or equipment level (level AG-E in FIG. 1), individual units can be specifically switched off during operation to protect someone, such as by inhibiting a lifting mechanism if a trolley is not in a defined position. Finally, the actuator level (level AK-E in FIG. 1) represents the last link in the chain in which, for example, load voltages are safely switched off, or the like, by the actuators AKT1, AKT2, AKT3. Typical actuators are contactors, isolating switches and the like.

FIG. 4 shows the overall matrix GM which results from the automatic combination of the safety matrices NA-M, SK-M, BM-M of FIG. 3. Here, the safety matrix NA-M has been inserted in the safety matrix SK-M, after which the result would in turn be inserted in the safety matrix BM-M. This is also referred to as a top-down process. The logic links (“cause”-“effect”) are each once again represented as an “X” in the overall matrix GM. The logic links in the last two columns, which are marked as “generated auxiliary logic” GHL in FIG. 4, have in this case been produced automatically, and are not relevant for the control program. The GHL columns in the generated auxiliary logic GHL simplify the configuration process and the legibility of the GM and can be used for documentation purposes, since they indicate the association with the respective hierarchies. In this case, the optimum code required for the run time is compiled from the column BM. In order to generate the overall matrix GM, the rule has been applied that the “effect” of a super-ordinate level reaches all the subordinate levels which are dependent on it as a “cause”, but not vice versa. The originally super-ordinate level of the emergency-off circuit is therefore filled out as the last line in the overall matrix, with the three logic links expressing the fact that both the protection circuit SK and the equipment item BM must likewise be switched to a safe state when the emergency-stop button is operated. Conversely, although operation of the scanner S switches off the equipment item BM, this does not lead to operation of the super-ordinate emergency-off circuit NA, with which even further equipment items BM (not illustrated) can possibly be associated, which are not protected by the scanner S and therefore should not be switched off when the scanner S is initiated.

In principle, the abovementioned procedure allows the generic, automatic production of a safety-related program even over a plurality of controllers in an automation arrangement. Once simple safety matrices have been produced, as shown in FIG. 3, equipment items and units can be categorized by type. Components which have already been validated can thus be used as part of a library for a plurality of projects. This also simplifies a subsequent acceptance process by authorities, etc. The process of switching off an individual equipment item or an individual safety circuit (e.g., a protection circuit) can be clearly configured in a small safety matrix and can then be associated with various protection circuits. This is done by activation of a “cause” from the corresponding super-ordinate hierarchy level or super-ordinate safety matrix. Changes such as addition or deletion of relationships are easily performed throughout the entire safety matrix GM. As a result, an easily legible and easily comprehensible representation of the complex safety-related facility is provided, which can not only be used for clear representation of the relationships but can also be implemented automatically by a suitable software component, such as a programmer plug-in, in a safety-related program for one or more controllers.

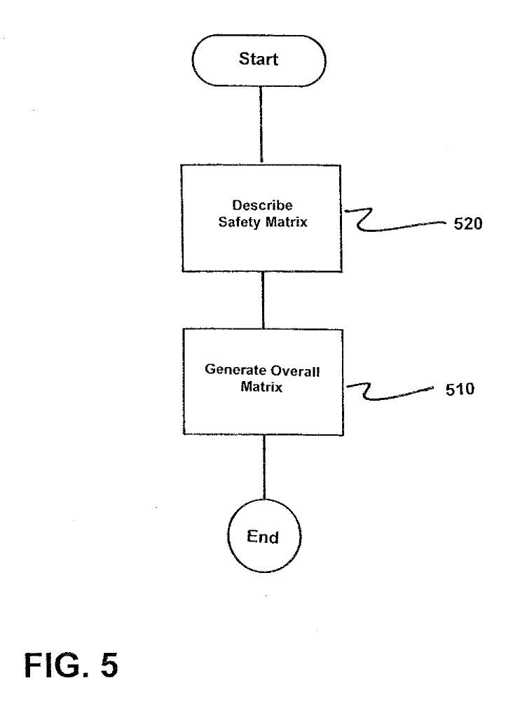

FIG. 5 is a flow chart illustrating the method in accordance with the invention. The method comprises describing a subordinate one of said plural protection circuits (NA, SK) and a super-ordinate one of said plural protection circuits (NA, SK) in a safety matrix (NA-M, SK-M), as indicated 510. Next, an overall matrix (GM) is generated from the safety matrix (NA-M, SK-M) of the subordinate and the super-ordinate protection circuits (NA, SK), as indicated in step 520. In accordance with the disclosed embodiments, the overall matrix (GM) provides an indication of a connection of said plural protection circuits (NA, SK).

Thus, while there are shown, described and pointed out fundamental novel features of the invention as applied to preferred embodiments thereof, it will be understood that various omissions and substitutions and changes in the form and details of the illustrated apparatus, and in its operation, may be made by those skilled in the art without departing from the spirit of the invention. Moreover, it should be recognized that structures shown and/or described in connection with any disclosed form or embodiment of the invention may be incorporated in any other disclosed or described or suggested form or embodiment as a general matter of design choice.

What is claimed is:

1. A method for logical connection of a plurality of protection circuits in an industrial automation arrangement, comprising:
describing each of a subordinate one of said plural protection circuits and a super-ordinate one of said plural protection circuits in respective safety matrices; and
generating an overall matrix from the safety matrices of the subordinate and the super-ordinate protection circuits;
wherein the overall matrix provides an indication of a connection of said plural protection circuits.

2. The method as claimed in patent claim 1, wherein said generating step comprises inserting the safety matrix of the subordinate protection circuit and logic links contained within the subordinate protection circuit into the safety matrix of the super-ordinate protection circuit of said plural protection circuits to generate the overall matrix.

3. The method as claimed in claim 1, wherein each of said plural protection circuits is recorded in a project description of the industrial automation arrangement; and
wherein a hierarchy of each of said plural protection circuits and the hierarchy of the safety matrix are read from at least one of a resource hierarchy and a group hierarchy in the project description of the industrial automation arrangement.

4. The method as claimed in claim 3, wherein a representation of the industrial automation arrangement comprising a tree structure forms the project description of the industrial automation arrangement.

5. The method as claimed in claim 1, further comprising:
defining an effect which is linked to an initiating condition for the safety matrix of each of said plural protection circuits;
wherein an effect of an originally super-ordinate safety matrix in the overall matrix in each case provides an initiating event on the safety matrix of each of said plural protection circuits which is subordinate to the super-ordinate safety matrix.

6. The method as claimed in claim 1, wherein the overall matrix at least one of produces a safety-related program for at least one of the industrial automation arrangement and represents safety relationships in the industrial automation arrangement.

7. The method as claimed in claim 1, further comprising:
generating auxiliary logic in the overall matrix.

8. The method as claimed in claim 7, wherein the auxiliary logic is used for documentation purposes.

9. A configuration device for an industrial automation arrangement, wherein the configuration device is configured to at least one partially or fully automatically:
describe each of a subordinate one of a plurality of protection circuits and a super-ordinate one of said plural protection circuits in respective safety matrices; and
generate an overall matrix from the safety matrices of the subordinate and the super-ordinate protection circuits;
wherein the overall matrix provides an indication of a connection of said plural protection circuits.

10. The configuration device as claimed in claim 9, wherein the configuration device comprises a software component of a programmer for the industrial automation arrangement.
